(19) United States
(12) Patent Application Publication
(10) Pub. No.: US 2023/0243378 A1
(43) Pub. Date: Aug. 3, 2023

(54) DEVICE AND METHOD FOR SURFACE MOUNTING OF FLAT PANELS

(71) Applicant: SIGNIFY HOLDING B.V., EINDHOVEN (NL)

(72) Inventor: John Jeffery BUSE, MANTACHIE, MS (US)

(21) Appl. No.: 17/928,766

(22) PCT Filed: Jul. 13, 2021
(86) PCT No.: PCT/EP2021/069457

§ 371 Date: Nov. 30, 2022

Related U.S. Application Data
(60) Provisional application No. 63/052,504, filed on Jul. 16, 2020.

(30) Foreign Application Priority Data
Aug. 6, 2020 (EP) 20189778.2

(51) Int. Cl. F16B 13/00; F21S 8/02

(52) U.S. Cl. CPC F16B 13/002; F21S 8/026

(57) ABSTRACT

Inventive devices and methods for mounting a flat panel surface onto a flat receiving surface. The devices include a recessed extension spring (306) which results in the surfaces being joined without resulting in any appreciable gap between the panel and the flat receiving surface.

The present invention is directed to a device for mounting flat panels onto a flat receiving surface in a manner that increases speed and ease of the installation process, without resulting in any gap between the panel and the surface on which it is mounted. By way of example, the device permits light emitting diode (LED) flat panels used in recessed lighting luminaires, to be thinner and to be easily mounted to a flat surface.

The current invention can be applied to multiple situations in which a flat panel surface is to be mounted to another flat surface, such as a ceiling or a wall. As the claimed invention has unique advantages in replacing recessed lighting luminaires with slimmer LED light fixtures, much of the discussion below relates to such luminaires. However, it should be noted that the invention is not limited to this field of use. That is, the advantages of the invention discussed below are applicable to other flat surface mounting structures involving flat panels.

Recessed luminaires came into application in the 1950s when a metal box or cylinder (i.e., a “recessed housing”) with a lamp in it was placed above a hole in the ceiling. As depicted in FIG. 1, this type of luminaire provided a unique unobtrusive look since essentially all portions of the luminaire were located above the ceiling. It also had the ability to provide a sharp cut off of light as the light passes through the aperture created by the hole in the ceiling. As different light sources have been developed, they have replaced the original incandescent lamp in the recessed housing. That is, recessed luminaires are currently available with incandescent, HID, fluorescent and even LED light sources.

As depicted in FIG. 2, the construction of traditional recessed luminaires involves a substantial amount of material (metal) contained in the recessed housing itself (204), plaster frame (206) and the mounting brackets (202). The height of the recessed housing can limit the locations where the luminaire can be installed since there must be room above the ceiling to fit the tall recessed housing. The opening (aperture) in the ceiling is typically large (e.g., 4″-8″) and as such requires additional care and often a special tool to cut. Since the size of the opening is essentially the finished size, there is very little latitude for positioning error. There is only one opportunity to position the luminaire opening correctly if installing after the ceiling is in place. In addition, the requirements of a large opening and the structure directly above that opening may preclude installation of the luminaire in the desired position of the ceiling. That is, by way of examples, the space above the mounting location may contain ceiling joists, duct work, or even pipes that are too close to accommodate the recessed housing in the desired location of the luminaire. In addition, heat generated within the recessed housing unit may also preclude installation where insufficient space above the unit is available. Many municipalities have building codes that require a minimum heat dissipation space, which includes how close ceiling insulation can be positioned.

U.S. Pat. No. 3,001,252 A relates to a fastening device. The fastening device has a plunger mechanism that includes a body member and a latch element which can be aligned with the body member when in one position and be displaced therefrom when in a second position.

The present disclosure is directed to inventive devices and methods that eliminates the recessed housing altogether. This saves material, weight and cost. Accordingly to one aspect of the invention, the light source is LED based and is located solely on the room side of the ceiling. This arrangement means that the hole in the ceiling need not be much larger than that required for an electrical connection and is therefore small in relation to the light source. This allows for easy repositioning of the luminaire should the hole be located incorrectly or the user later decide to relocate the luminaire. Further, the invention contemplates a novel method of securing the light source to the ceiling, thereby permitting a thinner design of the luminaire. Still further, even with the thinner design, no appreciable gap results between the light source and the ceiling.

As described below, installation of the invention's luminaire requires three relatively small holes in the mounting surface. Since these holes are small, conventional drill bits can be used. The luminaire design of the present invention reduces the materials and hence the cost of the luminaire. The present invention allows installation in a greater number of applications, and the ease of installation is increased by forgoing the requirement to cut a large opening in the ceiling. The small mounting holes also allow easy relocation of the luminaire should it be positioned incorrectly or relocation is desired. In particular, the luminaire itself can simply hide the incorrect hole locations when repositioning occurs within a distance that can be covered by the luminaire ‘trim.’ Further, when the repositioning occurs at a greater distance, the smaller hole(s) involved are readily repaired.

Further, the present invention permits greater flexibility in positioning the lighting apparatus should space above the ceiling be limited or restricted by the presence of various objects above the ceiling. Still further, the present invention, by not creating a relatively large opening in the ceiling (and a corresponding gap in the insulation above the opening), provides better insulation of the room below for heating/air-conditioning functions.

For a better understanding of exemplary embodiments and to show how the same may be carried into effect, reference is made to the accompanying drawings. It is stressed that the particulars shown are by way of example only and for purposes of illustrative discussion of the preferred embodiments of the present disclosure, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### IN THE ACCOMPANYING DRAWINGS

FIG. 1 illustrates a room view of a traditional recessed lighting trim;

FIG. 2 illustrates an attic view of an exemplary prior art recessed luminaire and its mounting structure;

FIG. 3A illustrates a cross-sectional view of the mounting device of the present invention;

FIG. 3B illustrates a perspective view of the mounting device of the present invention;

FIG. 4 is a perspective view of a pair of the invention's mounting devices attached to a flat receiving surface, such as a ceiling or wall of a room;

FIG. 5 is a perspective view of a flat panel being attached to a flat receiving surface using two mounting devices of the present invention; and,

FIG. 6 illustrates in greater detail the engagement of the mounting device's spring with the flat panel to be mounted.

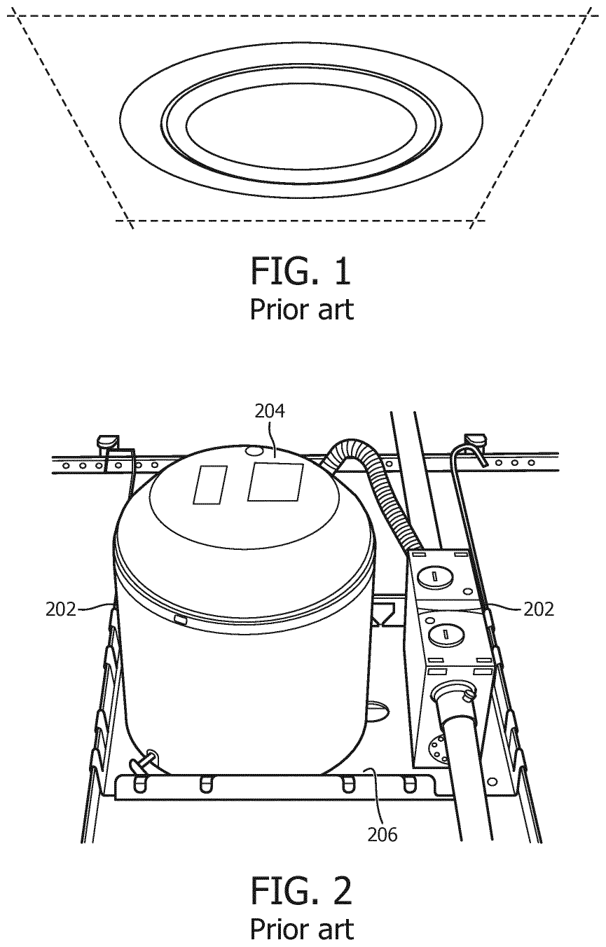

It is to be understood that the figures and descriptions of the present invention described herein have been simplified to illustrate the elements that are relevant for a clear understanding of the present invention, while eliminating, for purposes of clarity many other elements. However, because these omitted elements are well-known in the art, and because they do not facilitate a better understanding of the present invention, a discussion of such element is not provided herein. The disclosure herein is directed to also variations and modifications known to those skilled in the art.

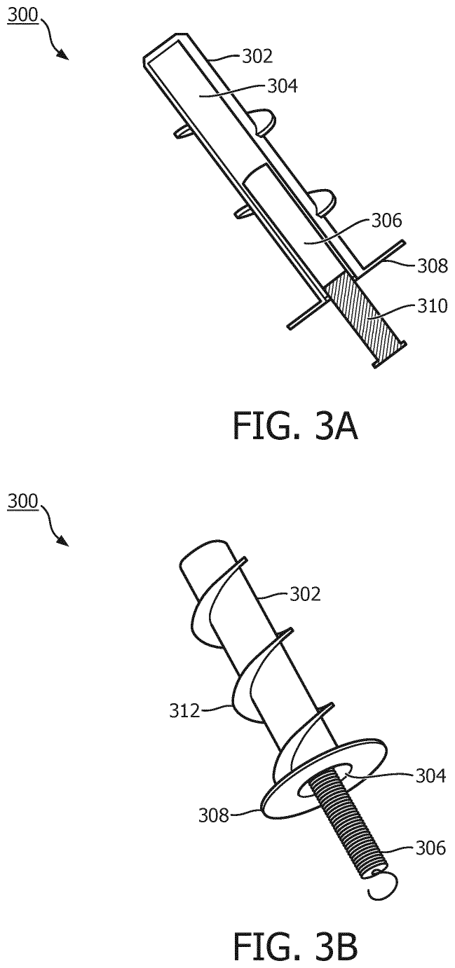

FIGS. 3A and 3B illustrate an exemplary mounting device 300 of the present invention. While this fixture resembles the appearance of a conventional drywall anchor, the main body or stem 302 has a hollow section 304 which contains an extension spring 306. FIG. 3A illustrates such a spring 306 that is positioned in the hollow section such that it does not extend beyond the bottom flange 308 of the stem 302. A flexible handle 310 is attached to the end of the spring so that in use, the spring can be extended from the hollow section and used to secure two objects together—as described below.

It should be noted that in some embodiments, the use of a flexible handle 310 (e.g., a ribbon, tape, string, or light wire) permits the mounting device 300 to be attached to the receiving flat surface in a manner similar to methods employed in installing conventional drywall anchors. That is, by way of example, a suitable size hole is drilled in the receiving flat surface, and the mounting device 300 is gently hammered into the hole. Helical protrusions 312 on the outer surface of the mounting device 300 thus permit the device to be secured to the receiving flat surface in a manner well-known in the art.

In further embodiments, the flexible handle 310 can be positioned totally within the hollow section, thereby permitting the mounting device to be attached to the receiving flat surface using a screw driver to turn the mounting device into the hole—again, in a manner similar to methods employed in installing conventional drywall anchors. This latter method requires that the bottom flange 308 of the mounting device be adapted to mate with an appropriate screw driver head (not illustrated).

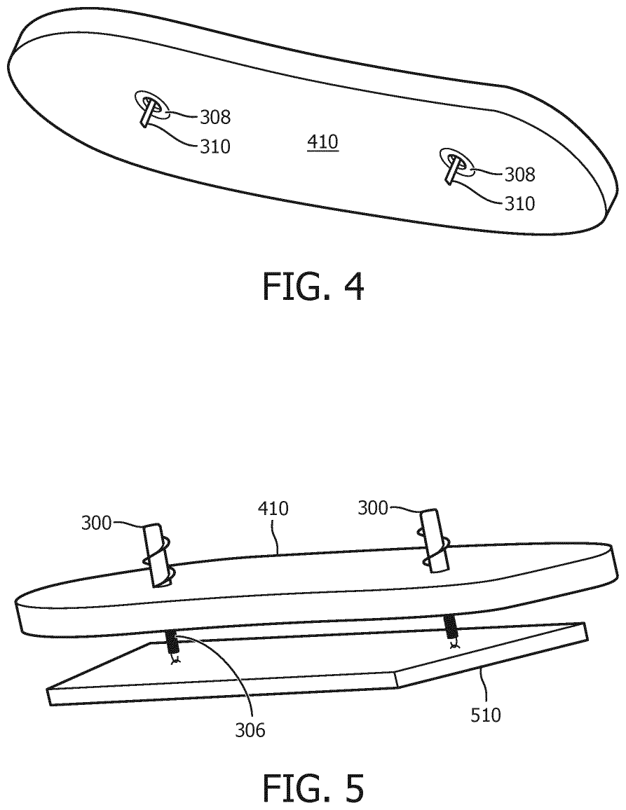

FIG. 4 is a perspective view of the mounting device of the present invention that has been secured to a receiving surface 410. In this illustration, the receiving surface is a section of a ceiling. As the ceiling is being viewed from below, only the bottom flange 308 and flexible handle of the mounting device is visible. That is, in those embodiments in which the flexible handle 310 had been recessed within the hollow section 304, it has now been withdrawn from the hollow section and is hanging below the mounting device.

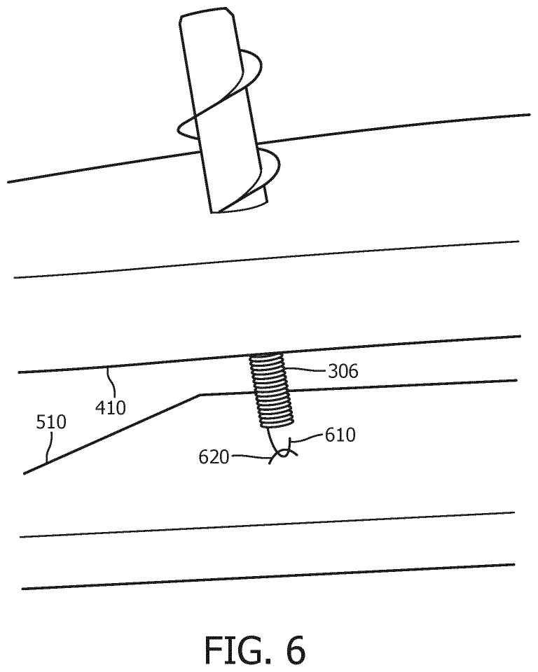

FIG. 5 is a perspective view of a flat panel 510 being attached to a flat receiving surface 410 using two mounting devices 300 of the present invention. As illustrated, extension spring 306 has been extended out of the hollow section of each mounting device and attached to flat panel 510. FIG. 6 illustrates in greater detail how a loop or hook 610 at the end of the extension spring 306 connects to an eyelet 620 on the flat panel 510. In this particular embodiment, the small size of the eyelets permits each to be retracted into the hollow section 304 of the respective mounting device once tension on the extension springs is released. Accordingly, the receiving flat surface 410 and the flat panel 510 would lie flush against each other once tension on the extension springs is released.

As noted above, the present invention has particular applicability to LED flat panels being mounted to a surface of a room. It is contemplated that the LED flat panels could be sold as part of an LED luminaire kit that includes a template to mark the hole positions on the room surface to accurately place mounting devices to mate up with the eyelets on the LED flat panel. As is well-known in the art, in installing such an LED flat panel, an additional hole would be required in the receiving surface 410 (i.e. the room surface) to accommodate the electrical connection to the LED driver that would be situated exterior to the room.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A mounting device for mounting a flat panel onto a receiving surface, the device adapted to be secured to the receiving surface, the receiving surface having a hole creating a passageway between an interior side and a back side of the receiving surface, the device comprising:
a stem 302, having a proximal end and a distal end; and wherein the stem 302 has a hollow section having an opening at the proximal end;
a retaining means 308 such that in use, the distal end of the stem 302 extends through the hole, and the stem 302 is secured to the receiving surface with the proximal end substantially even with the surface of the interior side of the receiving surface;
an extension spring 306 having a first end secured within the hollow section, wherein in a relaxed state, the spring lies totally within the hollow section;
the extension spring 306 having a handle 310 at a second end, opposite the first end, the handle enabling the spring to be extended outside of the hollow section;
wherein the extension spring 306, once extended outside of the hollow section and attached to the flat panel, has sufficient tension to secure the flat panel against the receiving surface.

2. The mounting device of claim 1 wherein the stem 302 has a threaded exterior surface and the retaining means 308 is selected from the group consisting of a toggle bolt arrangement, a molly bolt arrangement, and a locking nut.

3. The mounting device of claim 1 wherein the handle 310 is removably fixed to the second end of the extension spring 306, and is constructed of a material selected from the group consisting of ribbon, tape, string, light wire and combinations thereof.

4. The mounting device of claim 1 wherein the second end of the extension spring 306 terminates in a hook 610, said hook 610 being designed to engage an eyelet 620 on the surface of the flat panel 510.

5. The mounting device of claim 4 wherein the size of the eyelet 620 and the tension on the extension spring 306 enables the eyelet 620 to be pulled into the hollow section once the flat panel 510 is attached.

6. The mounting device of claim 1 wherein the second end of the extension spring terminates 306 in an eyelet 620, said eyelet being designed to engage a hook 610 on the surface of the flat panel 510.

7. The mounting device of claim 6 wherein the size of the hook 610 and the tension on the extension spring 306 enables the hook 610 to be pulled into the hollow section once the flat panel 510 is attached.

8. A kit for installing a flat panel LED luminaire, the kit comprising a plurality of mounting devices as recited in claim 1.

9. The kit of claim 8, further comprising a template to be used in locating the exact locations of passageway holes on the receiving surface.

10. A method of installing a flat panel onto a flat receiving surface using the mounting device of claim 1; the method comprising:
drilling a hole in the flat receiving surface,
securing the stem of the mounting device into the hole such that the proximal end is positioned substantially even with the surface of the receiving device;
grasping the handle of the mounting device and extending the second end of the extension spring 306 —out of the hollow section of the stem 302;
while maintaining tension on the extension spring 306, removing the handle and attaching the second end of the extension spring 306 onto the flat panel 510; and,
releasing tension on the extension spring 306 to secure the flat panel against the receiving surface.

11. The method of claim 10 wherein the securing step comprises hitting the proximal end of the stem 302 to drive the stem 302 into the receiving device.

12. The method of claim 10 wherein the mounting device has a screw head at its proximal end, and the securing step comprises turning the screw head with a screw driver to recess the stem into the receiving device.

13. The method of claim 10 wherein the flat panel comprises an LED luminaire, the method further comprising:
drilling an electrical access hole to permit an electrical connection of the luminaire with an LED driver, wherein the electrical access hole is of sufficient size so as not to cause a gap between the flat panel and the receiving surface when they are joined by the extension spring 306.
